(19) United States
(12) Patent Application Publication
(10) Pub. No.: US 2026/0104925 A1
(43) Pub. Date: Apr. 16, 2026

(54) SYSTEMS, METHODS, AND MEDIA FOR DETERMINING WORKLOAD TYPES

(71) Applicant: SK hynix NAND Product Solutions Corp., Rancho Cordova, CA (US)

(72) Inventors: Mark Anthony Golez, Folsom, CA (US); Ravi Motwani, Fremont, CA (US); Daniel McLeran, Loveland, CO (US)

(21) Appl. No.: 18/916,307

(22) Filed: Oct. 15, 2024

(51) Int. Cl. G06F 9/50

(52) U.S. Cl. CPC G06F 9/50

(57) ABSTRACT

Mechanisms, including systems, methods, and media, for determining a workload type are provided, the method including: receiving a workload; generating a plurality of sets of workload statistics using a hardware processor, wherein each set of workload statistics corresponds to a respective one of a plurality of intervals for the workload; providing the plurality of sets workload statistics to a classifier; receiving an output from the classifier; and based on the output from the classifier, determining a characteristic of the workload. In some embodiments, the characteristic of the workload is that the workload is steady state. In some embodiments, the characteristic of the workload is that the workload is of a given workload type.

### BACKGROUND

A solid-state drive's (SSD's) performance is dependent on properly determining a type of workload being presented to the SSD by a host. To optimize the performance of an SSD, the SSD attempts to determine a workload type and adjust its parameters accordingly. Existing mechanisms for determining workload types being presented to SSDs require a large amount of manual engineering effort and do not provide sufficient performance in many instances.

Accordingly, new mechanisms for determining workload types are desirable.

### SUMMARY OF THE INVENTION

In accordance with some embodiments, mechanisms, including systems, methods and media for determining workload types are provided.

In some embodiments, systems for determining a workload type are provided, the systems comprising: memory; and at least one hardware processor that is collectively configured to at least: receive a workload; generate a plurality of sets of workload statistics, wherein each set of workload statistics corresponds to a respective one of a plurality of intervals for the workload; provide the plurality of sets workload statistics to a classifier; receive an output from the classifier; and based on the output from the classifier, determine a characteristic of the workload. In some of these embodiments, the characteristic of the workload is that the workload is steady state. In some of these embodiments, the characteristic of the workload is that the workload is of a given workload type. In some of these embodiments, each of the plurality of workload statistics includes at least one of a moving average validity (MAV) of bands in the SSD processed for garbage collection, a read/write input/out mix of the corresponding workload, a queue depth of the corresponding workload, input/output sizes of the corresponding workload, a read type of the corresponding workload, a number of outstanding commands of the corresponding workload, start logical block address (LBA), and input/output source. In some of these embodiments, the at least one hardware processor is further collectively configured to at least configure a drive parameter of the SSD based on the determined characteristic of the workload. In some of these embodiments, the classifier is a neural network. In some of these embodiments, the neural network is a deep neural network.

In some embodiments, methods for determining a workload type are provided, the method comprising: receiving a workload; generating a plurality of sets of workload statistics using a hardware processor, wherein each set of workload statistics corresponds to a respective one of a plurality of intervals for the workload; providing the plurality of sets workload statistics to a classifier; receiving an output from the classifier; and based on the output from the classifier, determining a characteristic of the workload. In some of these embodiments, the characteristic of the workload is that the workload is steady state. In some of these embodiments, the characteristic of the workload is that the workload is of a given workload type. In some of these embodiments, each of the plurality of workload statistics includes at least one of a moving average validity (MAV) of bands in the SSD processed for garbage collection, a read/write input/out mix of the corresponding workload, a queue depth of the corresponding workload, input/output sizes of the corresponding workload, a read type of the corresponding workload, a number of outstanding commands of the corresponding workload, start logical block address (LBA), and input/output source. In some of these embodiments, wherein the method further comprises configuring a drive parameter of the SSD based on the determined characteristic of the workload. In some of these embodiments, the classifier is a neural network. In some of these embodiments, the neural network is a deep neural network.

In some of embodiments, non-transitory computer-readable media containing computer executable instructions that, when executed by a processor, cause the processor to perform a method for determining a workload type are provided, the method comprising: receiving a workload; generating a plurality of sets of workload statistics, wherein each set of workload statistics corresponds to a respective one of a plurality of intervals for the workload; providing the plurality of sets workload statistics to a classifier; receiving an output from the classifier; and based on the output from the classifier, determining a characteristic of the workload. In some of these embodiments, the characteristic of the workload is that the workload is steady state. In some of these embodiments, the characteristic of the workload is that the workload is of a given workload type. In some of these embodiments, each of the plurality of workload statistics includes at least one of a moving average validity (MAV) of bands in the SSD processed for garbage collection, a read/write input/out mix of the corresponding workload, a queue depth of the corresponding workload, input/output sizes of the corresponding workload, a read type of the corresponding workload, a number of outstanding commands of the corresponding workload, start logical block address (LBA), and input/output source. In some of these embodiments, wherein the method further comprises configuring a drive parameter of the SSD based on the determined characteristic of the workload. In some of these embodiments, the classifier is a neural network. In some of these embodiments, the neural network is a deep neural network.

### BRIEF DESCRIPTION OF THE DRAWINGS

FIG. 1 is a block diagram of example hardware that can be used in some embodiments.

FIGS. 2A and 2B are flow diagrams of example processes that can be used for training a machine learning classifier to determine workload types in accordance with some embodiments.

FIG. 3 is a flow diagram of an example process that can be used for using a machine learning classifier to determine workload types and control a solid state drive based on the determined workload types in accordance with some embodiments.

### DETAILED DESCRIPTION

In accordance with some embodiments, mechanisms, including systems, methods and media for determining workload types are provided.

In some embodiments, a workload type is determined using a machine learning classifier (hereinafter referred to as a “classifier”). Any suitable type of classifier that is based on machine learning can be used in some embodiments. For example, in some embodiments, a classifier can be implemented using a neural network. As a more particular example, in some embodiments, a classifier can be implemented using a deep neural network. In some embodiments, when the classifier is implemented as a neural network, any suitable activation functions, such as leaky ReLU and sigmoid activation functions, can be used in the neural network. In some embodiments, when the classifier is implemented as a neural network, the neural network can have any suitable number and size of hidden layers, use any suitable learning rate (e.g., 0.001), use any suitable loss function (e.g., a mean square error (MSE) loss function), be trained using an adaptive moment estimation (“Adam”) optimizer, and/or use a loss based technique such that when a loss threshold is reached (e.g., <10%) training is stopped to prevent an overfit.

In some embodiments, a classifier used to determine workload types can make this determination based upon any suitable inputs. For example, in some embodiments, a classifier used to determine a workload type of a workload can make this determination based upon a moving average validity (MAV) of bands in an SSD processed for garbage collection while processing the workload, a read/write input/out mix of the workload, a queue depth of the workload, input/output sizes of the workload, a read type (e.g., system or host) of the workload, a number of outstanding commands of the workload, start logical block address (LBA), input/output source (e.g., host, system, garbage collection, media policy, etc.), and/or any other suitable inputs.

In some embodiments, a classifier used to determine workload types can produce any suitable outputs. For example, in some embodiments, a classifier used to determine workload types can produce outputs including an indicator that indicates whether the workload is in a steady state, a type of workload that is currently being presented, for each of a plurality of workload types, a likelihood that the current workload is of that workload type, and/or any other suitable outputs.

Once the classifier determines a workload type, a controller of an SSD can adjust drive parameters of an SSD (or other suitable device) based on the determined workload type. Any suitable parameters can be adjusted in some embodiments. For example, in some embodiments, the parameters of an SSD shown in Table 1 can be controlled based on the workload type.

TABLE 1

| | Tuning | | Example | Example |
|---|---|---|---|---|
| # | Parameter | Description | Min | Max |
| 1 | MAX_READ_FORWARDED_{—} | Maximum limit on how | 0 | 200 |
| | DURING_PROGRAM_SUSPEND | many reads would be | | |
| | | allowed once a Program | | |
| | | command is suspended | | |
| 2 | MAX_READ_FORWARDED_{—} | Maximum limit on how | 0 | 255 |
| | DURING_ERASE_SUSPEND | many reads would be | | |
| | | allowed once an Erase | | |
| | | command is suspended | | |
| 3 | MAX_ALLOWED_{—} | Maximum limit on | 0 | 60 |
| | SUSPEND_FOR_ERASE | number of suspends | | |
| | | allowed per Erase | | |
| | | command | | |
| 4 | MAX_ALLOWED_{—} | Maximum limit on | 0 | count until it |
| | SUSPEND_FOR_PROGRAM | number of suspends | | reaches limit |
| | | allowed per program | | of 18 ms |
| | | command | | |
| 5 | MIN_TIME_FORWARD_{—} | Minimum forward | 0 | ERASE_SUSPEND_{—} |
| | PROGRESS_DURING_ERASE_{—} | progress allowed for an | | TBERS_MAX_TIME |
| | SUSPEND | ERASE before | | |
| | | suspending, wherein | | |
| | | forward progress is | | |
| | | allowing a command to | | |
| | | continue for an amount of | | |
| | | time to make sure the | | |
| | | command progresses | | |
| 6 | MAX_TIME_FORWARD_{—} | Maximum forward | 1150 | 5000 |
| | PROGRESS_DURING_ERASE_{—} | progress allowed for an | | |
| | SUSPEND | ERASE before | | |
| | | suspending, wherein | | |
| | | forward progress is | | |
| | | allowing a command to | | |
| | | continue for an amount of | | |
| | | time to make sure the | | |
| | | command progresses | | |
| 7 | MIN_TIME_FORWARD_{—} | Minimum forward | 0 | PROGRAM_SUSPEND_{—} |
| | PROGRESS_FOR_FIRST_{—} | progress allowed for a | | TPROG_MIN_TIME |
| | PROGRAM_SUSPEND | program before | | |
| | | suspending for the first | | |
| | | suspend, wherein forward | | |
| | | progress is allowing a | | |
| | | command to continue for | | |
| | | an amount of time to make | | |
| | | sure the command | | |
| | | progresses | | |
| 8 | MIN_TIME_FORWARD_{—} | Minimum forward | 250 | TPROG_TIME |
| | PROGRESS_DURING_{—} | progress allowed for a | | |
| | PROGRAM_SUSPEND | program before | | |
| | | suspending, wherein | | |
| | | forward progress is | | |
| | | allowing a command to | | |
| | | continue for an amount of | | |
| | | time to make sure the | | |
| | | command progresses | | |
| 9 | ENABLE_FORWARD_PROGRESS_{—} | A threshold number of | 0 | 10 |
| | THRESHOLD_FOR_PROGRAM_{—} | program suspends after | | |
| | SUSPEND | which the amount of | | |
| | | “program forward | | |
| | | progress” that NAND | | |
| | | media guarantees each | | |
| | | time a program is | | |
| | | suspended by a read (for | | |
| | | read QoS purposes) is | | |
| | | increased. | | |
| 10 | INTERNAL_READ_BUDGET | Maximum number of | 1 | MAX_DIE |
| | | Garbage collection reads | | |
| | | (internal read) allowed at a | | |
| | | time to be in flight | | |
| 11 | CMD_COMPLETION_{—} | Command polling timer | TPROG_MIN | TPROG_MAX |
| | POLLING_TIMER_{—} | for PROGRAM | | |
| | FOR_PROGRAM | | | |
| 12 | CMD_COMPLETION_{—} | Command polling timer | TBERS_MIN | TBERS_MAX |
| | POLLING_TIMER_FOR_ERASE | for ERASE | | |
| 13 | ADDITIONAL_CMD_{—} | Amount of delay added to | 0 | Target_latency |
| | DELAY_FOR_READ | Read commands to slow | | |
| | | them down | | |
| 14 | ADDITIONAL_CMD_{—} | Amount of delay added to | 0 | Target_latency |
| | DELAY_FOR_WRITE | Write commands to slow | | |
| | | them down | | |
| 15 | CMD_COMPLETION_{—} | Command polling timer | 1 us | MIN_TREAD to |
| | POLLING_TIMER_FOR_READ | for READ | | MAX_TREAD |
| 16 | TOTAL_SSD_BANDWIDTH | Total host and garbage | 500 Mibs | 1000 Mibs |
| | | collection allocation for | | |
| | | the entire SSD | | |
| 17 | HOST_BANDWIDTH | Host bandwidth allocation | 225 Mibs | 450 Mibs |
| 18 | GC_BANDWIDTH | Garbage collection | 225 Mibs | 450 Mibs |
| | | bandwidth allocation | | |
| 19 | MP_BANDWIDTH | Media policy bandwidth | 50 Mibs | 100 Mibs |
| | | allocation | | |

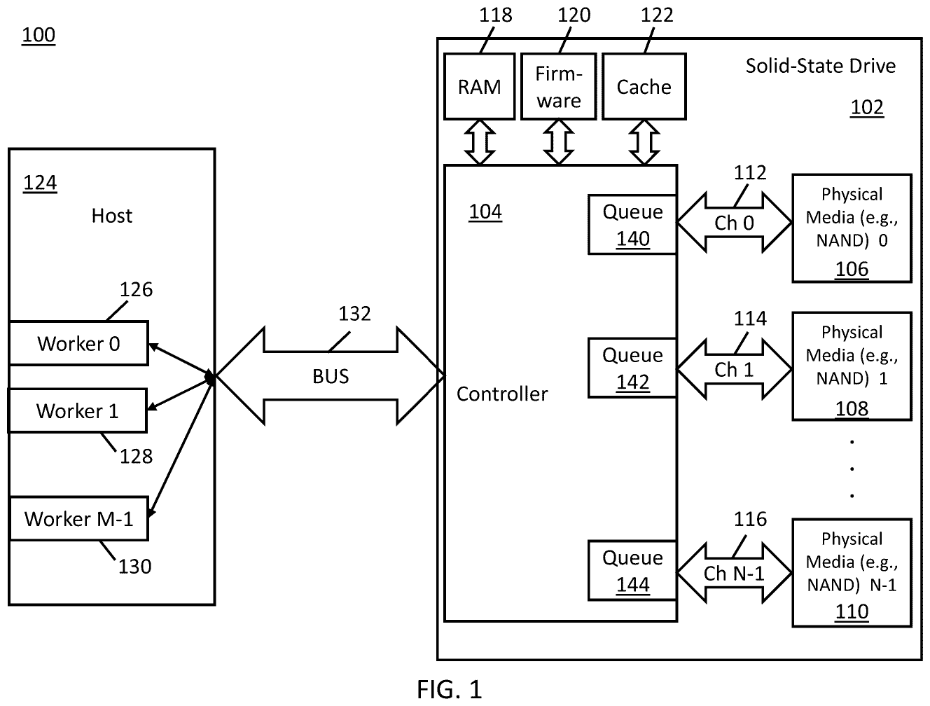

Turning to FIG. 1, an example block diagram of a solid-state drive 102 coupled to a host device 124 via a bus 132 in accordance with some embodiments is illustrated.

As shown, solid-state drive 102 can include a controller 104, physical media (e.g., NAND devices) 106, 108, and 110, channels 112, 114, and 116, random access memory (RAM) 118, firmware 120, and cache 122 in some embodiments. In some embodiments, more or fewer components than shown in FIG. 1 can be included. In some embodiments, two or more components shown in FIG. 1 can be included in one component.

Controller 104 can be any suitable controller for a solid-state drive in some embodiments. In some embodiments, controller 104 can include any suitable hardware processor(s) (such as a microprocessor, a digital signal processor, a microcontroller, a programmable gate array, etc.). In some embodiments, controller 104 can also include any suitable memory (such as RAM, firmware, cache, buffers, latches, etc.), interface controller(s), interface logic, drivers, etc. In some embodiments, controller 104 can be coupled to, or include (as shown), channel queues 140, 142, and 144 for transmitting commands (which can include command data) over channels 140, 142, and 144 to physical media 106, 108, and 110, respectively.

Physical media 106, 108, and 110 can be any suitable physical media for storing information (which can include data, programs, and/or any other suitable information that can be stored in a solid-state drive) in some embodiments. For example, the physical media can be NAND devices in some embodiments.

The physical media can include any suitable memory cells, hardware processor(s) (such as a microprocessor, a digital signal processor, a microcontroller, a programmable gate array, etc.), interface controller(s), interface logic, drivers, etc. in some embodiments. While three physical media (106, 108, and 110) are shown in FIG. 1, any suitable number D of physical media (including only one) can be used in some embodiments. Any suitable type of physical media (such as single-level cell (SLC) NAND devices, multilevel cell (MLC) NAND devices, triple-level cell (TLC) NAND devices, quad-level cell (QLC) NAND devices, penta-level cell (PLC) NAND, NAND with any other suitable levels of cells, 2D NAND devices, 3D NAND devices, NOR flash memory, any other suitable flash technology, phase change memory technology, and/or other any other suitable volatile and/or non-volatile memory storage technology) can be used in some embodiments. Each physical media can have any suitable size in some embodiments. While physical media 106, 108, and 110 can be implemented using NAND devices, the devices can additionally or alternatively use any other suitable storage technology or technologies, such as NOR flash memory or any other suitable flash technology, phase change memory technology, and/or other any other suitable non-volatile memory storage technology.

Channels 112, 114, and 116 can be any suitable mechanism for communicating information between controller 104 and physical media 106, 108, and 110 in some embodiments. For example, the channels can be implemented using conductors (lands) on a circuit board in some embodiments. While three channels (112, 114, and 116) are shown in FIG. 1, any suitable number C of channels can be used in some embodiments.

Random access memory (RAM) 118 can include any suitable type of RAM, such as dynamic RAM, static RAM, etc., in some embodiments. Any suitable number of RAM 118 can be included, and each RAM 118 can have any suitable size, in some embodiments.

Firmware 120 can include any suitable combination of software and hardware in some embodiments. For example, firmware 120 can include software programmed in any suitable programmable read only memory (PROM) in some embodiments. Any suitable number of firmware 120, each having any suitable size, can be used in some embodiments.

Cache 122 can be any suitable device for temporarily storing information (which can include data and programs in some embodiments), in some embodiments. Cache 122 can be implemented using any suitable type of device, such as RAM (e.g., static RAM, dynamic RAM, etc.) in some embodiments. Any suitable number of cache 122, each having any suitable size, can be used in some embodiments.

Host device 124 can be any suitable device that accesses stored information in some embodiments. For example, in some embodiment, host device 124 can be a general-purpose computer, a special-purpose computer, a desktop computer, a laptop computer, a tablet computer, a server, a database, a router, a gateway, a switch, a mobile phone, a communication device, an entertainment system (e.g., an automobile entertainment system, a television, a set-top box, a music player, etc.), a navigation system, etc. While only one host device 124 is shown in FIG. 1, any suitable number of host devices can be included in some embodiments.

In some embodiments, host device 124 can include workers 126, 128, and 130. While three workers (126, 128, and 130) are shown in FIG. 1, any suitable number of workers W can be included in some embodiments. In some embodiments, at least two workers can be included. A worker can be any suitable hardware and/or software that reads and/or writes data from and/or to solid-state drive 102.

Bus 132 can be any suitable bus for communicating information (which can include data and/or programs in some embodiments), in some embodiments. For example, in some embodiments, bus 132 can be a PCIE bus, a SATA bus, or any other suitable bus.

As described above, in accordance with some embodiments, a workload type can be determined by a machine learning classifier. In order for a machine learning classifier to determining a workload type, the machine learning classifier can be trained to do so and/or be configured to do so based on another machine learning classifier that was trained to do so.

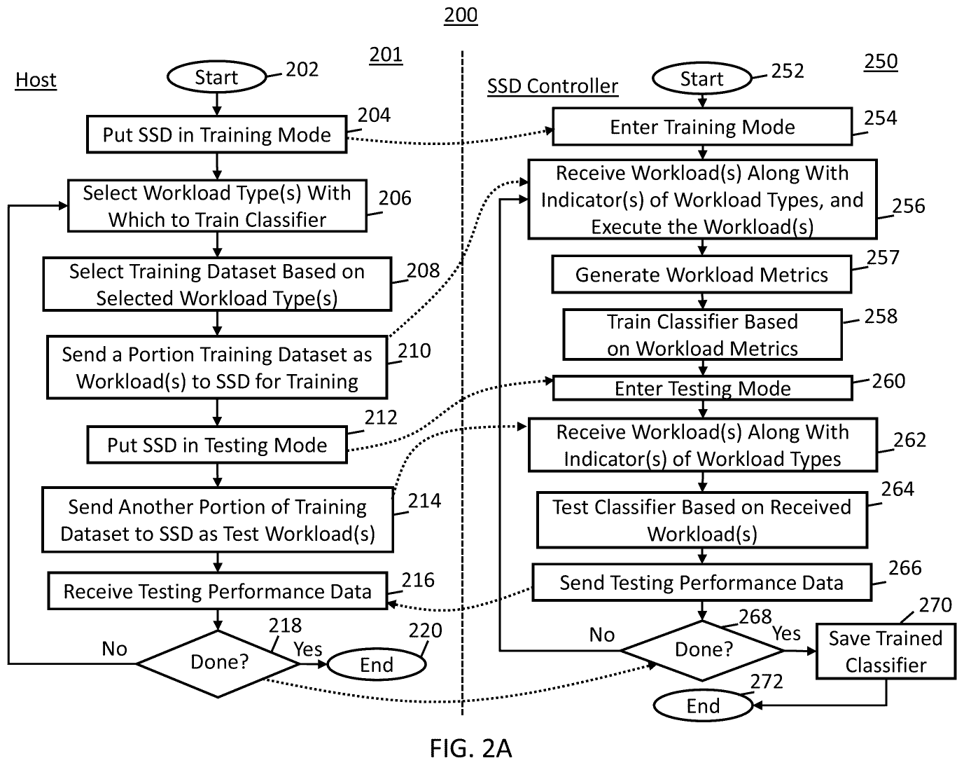

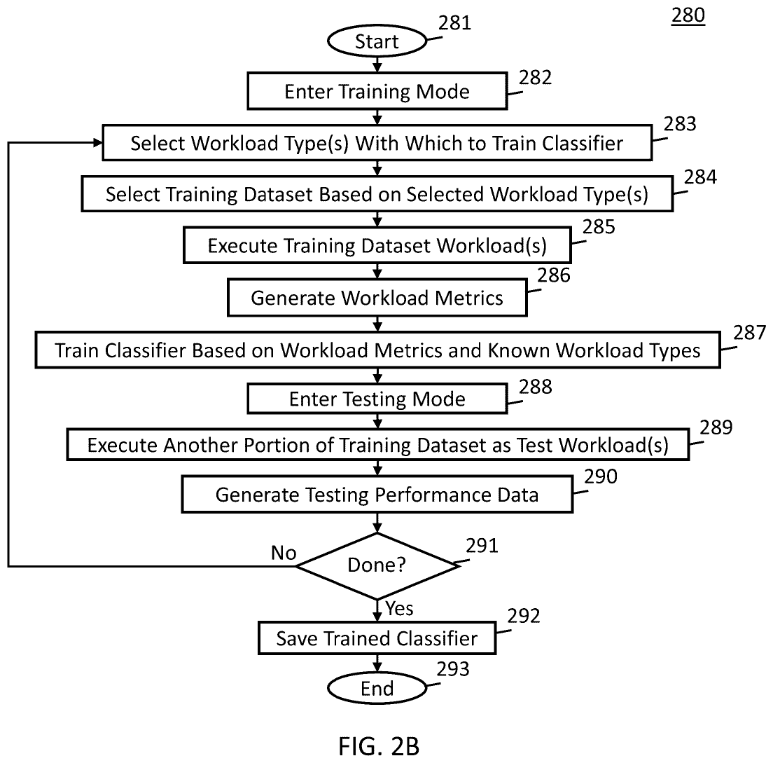

Turning to FIG. 2A, an example 200 of a process for training a machine learning classifier that can be used to determine a workload type of an SSD in accordance with some embodiments is illustrated. As shown, process 200 includes a portion 201 that is executed by a host and a portion 250 that is executed by an SSD controller, in some embodiments.

As shown, after process 201 begins at 202, the process puts the SSD in a training mode 204. Putting the SSD in a training mode can be accomplished in any suitable manner in some embodiments. For example, in some embodiments, process 201 can send a command to the SSD at 204 to put the SSD in a training mode.

After process 250 begins at 252, and in response to process 201 putting the SSD into a training mode, process 250 can enter the training mode at 254. Process can enter the training mode in any suitable manner. For example, in entering the training mode, process 250 can cause a classifier of the SSD to be configured to be trained. As another example, in some embodiments, a classifier can be initialized. More particularly, for example, when implemented with a neural network, the classifier can be initialized with normal Xavier initialization and zero biases.

Next, at 206, process 201 can select one or more workload types upon which the classifier in the SSD is to be trained. Any suitable workload types and suitable number of them can be selected at 206, and the workload types can be selected based on any suitable criteria or criterion. For example, in some embodiments, process 201 can select certain workload types that are applicable to a particular type of the SSD, a particular application for the SSD, a particular industry for which the SSD is intended, one or more particular customers, etc.

Then, at 208, process 201 can select a training dataset based on the selected workload type(s). Any suitable training dataset can be selected in any suitable manner, and the training dataset can have any suitable size. For example, in some embodiments, the training dataset can be selected to have workload examples that correspond to the select workload types.

In some embodiments, the training dataset can have any suitable content. For example, in some embodiments, the training dataset can include workload commands and data as well as indicators that indicate, for each portion of the training dataset, the workload type that corresponds to that portion.

Next, at 210, process 201 can send a portion of the training dataset as one or more workloads to the SSD for training. This portion can be sent in any suitable manner. For example, this portion can be sent in the same manner as a corresponding non-training workload would be sent to the SSD, in some embodiments. More particularly, the portion can be sent to the SSD from the host as a series of commands along with corresponding data (if applicable). In some embodiments, the indicators of the workload type can be sent together with the commands and corresponding data (if applicable), while in other embodiments, the indicators of the workload type can be sent separate from the commands and corresponding data (if applicable).

At 256, process 250 can receive the workload(s) along with the indicator(s) of the workload types, and execute the workload(s).

Process 250 can generate workload metrics at 257. Any suitable workload metrics can be generated in any suitable manner. For example, in some embodiment, generated workload metrics can include a moving average validity (MAV) of bands in an SSD processed for garbage collection while processing the workload, a read/write input/out mix of the workload, a queue depth of the workload, input/output sizes of the workload, a read type (e.g., system or host) of the workload, a number of outstanding commands of the workload, start logical block address (LBA), input/output source (e.g., host, system, garbage collection, media policy, etc.), and/or any other suitable metrics.

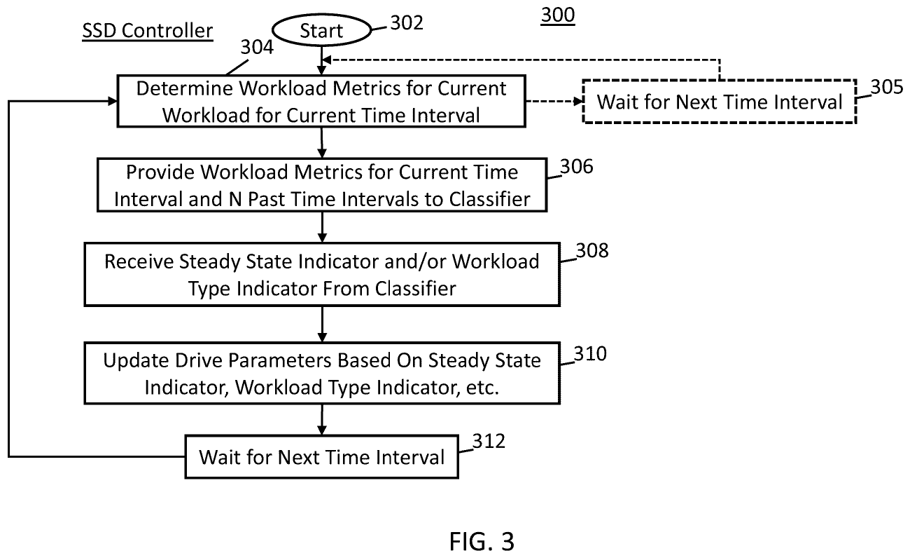

Next, at 258, process 250 can train the classifier using the received workload(s). The classifier can be trained using the received workload(s) in any suitable manner, in some embodiments. For example, in some embodiments, process 250 can provide the classifier with workload metrics from a given number of intervals (as described below in connection with 306 of FIG. 3), receive an output from the classifier, and modify the classifier through backpropagation based on the output and the workload type(s) indicated by the training dataset. In some embodiments, the classifier can be trained using an adaptive moment estimation (“Adam”) optimizer.

After training is complete, at 212, process 201 can put the SSD into a testing mode. Putting the SSD in a testing mode can be accomplished in any suitable manner in some embodiments. For example, in some embodiments, process 201 can send a command to the SSD at 212 to put the SSD in a testing mode.

In response to process 201 putting the SSD into a testing mode, process 250 can enter the testing mode at 260. Process 250 can enter the testing mode in any suitable manner, in some embodiments. For example, in entering the testing mode, process 250 can cause a classifier of the SSD to be configured to evaluate workloads presented to determine their workload types as well as monitor the accuracy of those determinations based on indicators of workload type(s) provided with the workloads.

Next, at 214, process 201 can send another portion of the training dataset to the SSD as test workload(s). This other portion can be sent to the SSD in any suitable manner, in some embodiments. For example, this portion can be sent in the same manner as a corresponding non-training workload would be sent to the SSD, in some embodiments. More particularly, the portion can be sent to the SSD from the host as a series of commands along with corresponding data (if applicable). In some embodiments, the indicators of the workload type can be sent together with the commands and corresponding data (if applicable), while in other embodiments, the indicators of the workload type can be sent separate from the commands and corresponding data (if applicable).

At 262, process 250 can receive the workload(s) along with the indicator(s) of the workload types, and execute the workload(s).

Then, at 264, process 250 can test the trained classifier based on the received workloads. Process 250 can test the trained classifier based on the received workloads in any suitable manner, in some embodiments. For example, in testing the trained classifier, process 250 can evaluate workloads presented to determine their workload types (e.g., as described below in connection with 304, 305, 306, 308, and 312 of FIG. 3) as well as monitor the accuracy of those determinations based on indicators of workload type(s) provided with the workloads, in some embodiments.

Next, at 266, process 250 can send testing performance data to process 201. This performance data can be sent in any suitable manner, in some embodiments. Any suitable performance data can be sent, in some embodiments. For example, in some embodiments, the performance data can include accuracy data.

Process 201 can receive testing performance data at 216.

At 218, process 201 can then determine, based on the performance data and/or any other suitable metric or combination of metrics, whether the classifier has been sufficiently trained. Any suitable performance data can be used to determine whether the classifier has been sufficiently trained, in some embodiments. For example, in some embodiments, process 201 can determine that the classifier has been sufficiently trained when the accuracy of the classifier is within one standard deviation or other statistic distance (e.g., 10%) of the known workload types indicated in the training data.

If process 201 determines at 218 that the classifier has not been sufficiently trained, the process can loop back to 206.

Otherwise, the process can end at 220.

At 268, process 250 can then determine, based on the performance data and/or any other suitable metric or combination of metrics, and/or based on an indicator sent from process 201 at 218, whether the classifier has been sufficiently trained. Any suitable performance data can be used to determine whether the classifier has been sufficiently trained, in some embodiments. For example, in some embodiments, process 201 can determine that the classifier has been sufficiently trained when the accuracy of the classifier is within one standard deviation or other statistic distance (e.g., 10%) of the known workload types indicated in the training data.

If process 250 determines at 268 that the classifier has been sufficiently trained, process 250 can loop back to 256.

Otherwise, the process can save the trained classifier at 270 and then end at 272. The trained classifier can be saved for later use in the present SSD and/or one or more other SSDs separate from the present SSD.

Turning to FIG. 2B, an example 280 of a process for training a machine learning classifier that can be used to determine a workload type in accordance with some embodiments is illustrated. Process 280 can be executed by any suitable computing device, such as a host, in some embodiments.

As shown, after process 280 begins at 281, the process can enter the training mode at 282. Process can enter the training mode in any suitable manner, in some embodiments. For example, in entering the training mode, process 280 can cause a classifier to be configured to be trained. As another example, in some embodiments, a classifier can be initialized. More particularly, for example, when implemented with a neural network, the classifier can be initialized with normal Xavier initialization and zero biases.

Next, at 283, process 280 can select one or more workload types upon which the classifier is to be trained. Any suitable workload types and suitable number of them can be selected at 283, and the workload types can be selected based on any suitable criteria or criterion. For example, in some embodiments, process 280 can select certain workload types that are applicable to a particular type of SSD, a particular application for an SSD, a particular industry for which an SSD is intended, one or more particular customers, etc.

Then, at 284, process 280 can select a training dataset based on the selected workload type(s). Any suitable training dataset can be selected in any suitable manner, and the training dataset can have any suitable size. For example, in some embodiments, the training dataset can be selected to have workload examples that correspond to the select workload types.

In some embodiments, the training dataset can have any suitable content. For example, in some embodiments, the training dataset can include workload commands and data as well as indicators that indicate, for each portion of the training dataset, the workload type that corresponds to that portion.

Next, at 285, process 280 can execute a portion of the training dataset as one or more workloads for training. This portion can be executed in any suitable manner. For example, this portion can be executed in the same manner as a corresponding non-training workload would be executed in an SSD, in some embodiments. As another example, in some embodiments, process 280 can simulate execution of the training dataset as one or more workloads. As yet another example, in some embodiments, when training a classifier for one or more given SSDs, workload metrics/information corresponding to workload executions on one or more other SSDs can be used to simulate the execution of workloads on the one or more given SSDs. This allows SSD classifiers to be trained based on past data from different SSDs and different host configurations.

Process 280 can generate workload metrics at 286. Any suitable workload metrics can be generated in any suitable manner, in some embodiments. For example, in some embodiments, generated workload metrics can include a moving average validity (MAV) of bands in an SSD processed for garbage collection while processing the workload, a read/write input/out mix of the workload, a queue depth of the workload, input/output sizes of the workload, a read type (e.g., system or host) of the workload, a number of outstanding commands of the workload, start logical block address (LBA), input/output source (e.g., host, system, garbage collection, media policy, etc.), and/or any other suitable metrics.

Next, at 287, process 280 can train the classifier based on the workload metric(s) and known workload type(s) of the executed workload(s). The classifier can be trained using the received workload(s) in any suitable manner, in some embodiments. For example, in some embodiments, process 280 can provide the classifier with workload metrics from a given number of intervals (as described below in connection with 306 of FIG. 3), receive an output from the classifier, and modify the classifier through backpropagation based on the output and the workload type(s) indicated by the training dataset. In some embodiments, the classifier can be trained using an adaptive moment estimation (“Adam”) optimizer.

After training is complete, at 288, process 280 can enter a testing mode. Process 280 can enter the testing mode in any suitable manner, in some embodiments. For example, in entering the testing mode, process 280 can cause a classifier of the SSD to be configured to evaluate workloads presented to determine their workload types as well as monitor the accuracy of those determinations based on indicators of workload type(s) provided with the workloads.

Next, at 289, process 280 can execute another portion of the training dataset as test workload(s). For example, this other portion can be executed in the same manner as a corresponding non-training workload would be executed in an SSD, in some embodiments. As another example, in some embodiments, process 280 can simulate execution of the training dataset as one or more workloads.

Then, at 290, process 280 can generate testing performance data. This performance data can be generated in any suitable manner, and any suitable performance data can be generated, in some embodiments. For example, in generating the performance data, process 280 can evaluate workloads presented to determine their workload types (e.g., as described below in connection with 304, 305, 306, 308, and 312 of FIG. 3) as well as monitor the accuracy of those determinations based on indicators of workload type(s) provided with the workloads, in some embodiments.

At 291, process 280 can then determine, based on the performance data and/or any other suitable metric or combination of metrics, whether the classifier has been sufficiently trained. Any suitable performance data can be used to determine whether the classifier has been sufficiently trained, in some embodiments. For example, in some embodiments, process 201 can determine that the classifier has been sufficiently trained when the accuracy of the classifier is within one standard deviation or other statistic distance (e.g., 10%) of the known workload types indicated in the training data.

If process 280 determines at 291 that the classifier has not been sufficiently trained, the process can loop back to 283.

Otherwise, the process can save the trained classifier at 292 and then end at 293. The trained classifier can be saved for later use in one or more SSDs.

Turning to FIG. 3, an example 300 of a process for using a machine learning classifier to determine workload types in accordance with some embodiments is illustrated. Process 300 can be executed by an SSD controller, in some embodiments.

After process 300 begins at 302, the process can determine current workload metrics for a current workload for a current time interval at 304. Process 300 can determine any suitable current workload metrics in any suitable manner, in some embodiments. For example, in some embodiments, process 300 can determine one or more of a moving average validity (MAV) of bands in an SSD processed for garbage collection while processing the workload, a read/write input/out mix of the workload, a queue depth of the workload, input/output sizes of the workload, a read type (e.g., system or host) of the workload, a number of outstanding commands of the workload, start logical block address (LBA), input/output source (e.g., host, system, garbage collection, media policy, etc.), and/or any other suitable inputs. The current time interval can have any suitable duration, in some embodiments. For example, the current time interval can have a duration of a value from 1-25 ms in some embodiments. In some embodiments, as represented by the dashed lines around box 305 and the dashed lines between box 305 and box 304, when process 300 first begins, 304 and 305 (at which process 300 can wait for the next interval) can be repeated over N+1 intervals before proceeding to 306.

Next, at 306, process 300 can provide the workload metrics for the current time interval and N past time intervals as inputs to the classifier. N can have any suitable value, in some embodiments. For example, in some embodiments, N can be two so that workload metrics for three total time intervals are provided to the classifier. These inputs can be provided in any suitable manner, in some embodiments.

Then, at 308, process 300 can receive a steady state indicator, workload type indicator, and/or any other suitable output from the classifier. Such output(s) can be received in any suitable manner, in some embodiments.

At 310, process 300 can next update drive parameters of the SSD based on the outputs of the classifier. For example, in some embodiments, process 300 can update drive parameters (such as the drive parameters described in Table 1) of the SSD based on the SSD being determined to be in a steady state, based on the workload being of a given type, and/or based on any other suitable criteria or criterion. Any suitable drive parameters can be updated in any suitable manner, in some embodiments. For example, the drive parameters listed in Table 1 can be updated in some embodiments.

Process 300 can next wait for the next time interval at 312 and then loop back to 304.

In some embodiments, at least some of the above-described blocks of the processes of FIGS. 2 and 3 can be executed or performed in any order or sequence not limited to the order and sequence shown in and described in connection with the figures. Also, some of the above blocks of the processes of FIGS. 2 and 3 can be executed or performed substantially simultaneously where appropriate or in parallel to reduce latency and processing times in some embodiments. Additionally or alternatively, some of the above described blocks of the processes of FIGS. 2 and 3 can be omitted in some embodiments.

In some embodiments, any suitable computer readable media can be used for storing instructions for performing the functions and/or processes herein. For example, in some embodiments, computer readable media can be transitory or non-transitory. For example, non-transitory computer readable media can include media such as non-transitory forms of magnetic media (such as hard disks, floppy disks, and/or any other suitable magnetic media), non-transitory forms of optical media (such as compact discs, digital video discs, Blu-ray discs, and/or any other suitable optical media), non-transitory forms of semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

As can be seen from the description above, new mechanisms (which can include systems, methods, and media) for determining workload type are provided. These mechanisms can improve the performance of SSDs by more accurately determining the workload type and by enabling the SSD to be configured to match a determined workload type.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A system for determining a workload type, comprising:
memory; and
at least one hardware processor that is collectively configured to at least:
receive a workload;
generate a plurality of sets of workload statistics, wherein each set of workload statistics corresponds to a respective one of a plurality of intervals for the workload;
provide the plurality of sets workload statistics to a classifier;
receive an output from the classifier; and
based on the output from the classifier, determine a characteristic of the workload.

2. The system of claim 1, wherein the characteristic of the workload is that the workload is steady state.

3. The system of claim 1, wherein the characteristic of the workload is that the workload is of a given workload type.

4. The system of claim 1, wherein each of the plurality of workload statistics includes at least one of a moving average validity (MAV) of bands in the SSD processed for garbage collection, a read/write input/out mix of the corresponding workload, a queue depth of the corresponding workload, input/output sizes of the corresponding workload, a read type of the corresponding workload, a number of outstanding commands of the corresponding workload, start logical block address (LBA), and input/output source.

5. The system of claim 1, wherein the at least one hardware processor is further collectively configured to at least configure a drive parameter of the SSD based on the determined characteristic of the workload.

6. The system of claim 1, wherein the classifier is a neural network.

7. The system of claim 6, wherein the neural network is a deep neural network.

8. A method for determining a workload type, comprising:
receiving a workload;
generating a plurality of sets of workload statistics using a hardware processor, wherein each set of workload statistics corresponds to a respective one of a plurality of intervals for the workload;
providing the plurality of sets workload statistics to a classifier;
receiving an output from the classifier; and
based on the output from the classifier, determining a characteristic of the workload.

9. The method of claim 8, wherein the characteristic of the workload is that the workload is steady state.

10. The method of claim 8, wherein the characteristic of the workload is that the workload is of a given workload type.

11. The method of claim 8, wherein each of the plurality of workload statistics includes at least one of a moving average validity (MAV) of bands in the SSD processed for garbage collection, a read/write input/out mix of the corresponding workload, a queue depth of the corresponding workload, input/output sizes of the corresponding workload, a read type of the corresponding workload, a number of outstanding commands of the corresponding workload, start logical block address (LBA), and input/output source.

12. The method of claim 8, further comprising configuring a drive parameter of the SSD based on the determined characteristic of the workload.

13. The method of claim 8, wherein the classifier is a neural network.

14. The method of claim 13, wherein the neural network is a deep neural network.

15. A non-transitory computer-readable medium containing computer executable instructions that, when executed by a processor, cause the processor to perform a method for determining a workload type, the method comprising:
receiving a workload;
generating a plurality of sets of workload statistics, wherein each set of workload statistics corresponds to a respective one of a plurality of intervals for the workload;
providing the plurality of sets workload statistics to a classifier;
receiving an output from the classifier; and
based on the output from the classifier, determining a characteristic of the workload.

16. The non-transitory computer-readable medium of claim 15, wherein the characteristic of the workload is that the workload is steady state.

17. The non-transitory computer-readable medium of claim 15, wherein the characteristic of the workload is that the workload is of a given workload type.

18. The non-transitory computer-readable medium of claim 15, wherein each of the plurality of workload statistics includes at least one of a moving average validity (MAV) of bands in the SSD processed for garbage collection, a read/write input/out mix of the corresponding workload, a queue depth of the corresponding workload, input/output sizes of the corresponding workload, a read type of the corresponding workload, a number of outstanding commands of the corresponding workload, start logical block address (LBA), and input/output source.

19. The non-transitory computer-readable medium of claim 15, further comprising configuring a drive parameter of the SSD based on the determined characteristic of the workload.

20. The non-transitory computer-readable medium of claim 15, wherein the classifier is a neural network.

21. The non-transitory computer-readable medium of claim 21, wherein the neural network is a deep neural network.
